(19) United States
(12) Patent Application Publication
(10) Pub. No.: US 2014/0063211 A1
(43) Pub. Date: Mar. 6, 2014

(54) NAKED EYE TYPE AND GLASSES TYPE SWITCHABLE STEREOSCOPIC DISPLAY DEVICE

(71) Applicants: WINTEK CORPORATION, Taichung City (TW); Dongguan Masstop Liquid Crystal Display Co., Ltd., Dongguan City (CN)

(72) Inventors: Chong-Yang Fang, Taichung City (TW); Wen-Chun Wang, Taichung City (TW); Chia-Hsiung Chang, Tainan City (TW); Yan-Yu Su, Changhua County (TW); Chia-Hung Yeh, Changhua County (TW); Wei-Chou Chen, Hsinchu City (TW)

(73) Assignees: WINTEK CORPORATION, Taichung City (TW); Dongguan Masstop Liquid Crystal Display Co., Ltd., Dongguan City (CN)

(21) Appl. No.: 14/016,253

(22) Filed: Sep. 3, 2013

(30) Foreign Application Priority Data
Sep. 3, 2012 (TW) 101132043

(51) Int. Cl. H04N 13/04

(52) U.S. Cl. CPC H04N 13/0402; H04N 13/0429
USPC 348/54

(57) ABSTRACT

A naked eye type and glasses type switchable stereoscopic display device includes a display panel and a switching module. The display panel provides first display image and second display image. The switching module includes a first transparent electrode, a second transparent electrode, a liquid crystal layer, and an electric field uniforming layer. The electric field uniforming layer is disposed between the liquid crystal layer and the second transparent electrode. The liquid crystal layer is driven by the second transparent electrode through the electric field uniforming layer to form liquid crystal lenses under a naked eye type stereoscopic display mode; the switching module provides a first phase retardation mode and a second phase retardation mode under a glasses type display mode. The first phase retardation mode provides a first polarization state to the first display image; the second phase retardation mode provides a second polarization state to the second display image.

### BACKGROUND OF THE INVENTION

1. Field of the Invention

The present invention relates to a stereoscopic display device, and more particularly, to a stereoscopic display device capable of switching between a naked eye type stereoscopic display mode and a glasses type stereoscopic display mode.

2. Description of the Prior Art

Display related technologies have progressed in recent years; stereoscopic display technologies and related applications have also developed flourishingly. The principle of the stereoscopic display technology includes delivering different images respectively to a left eye and a right eye of a viewer to give to the viewer a feeling of gradation and depth in the images, thereby generating the stereoscopic effect in the cerebrum of the viewer by analyzing and overlapping the images received separately by the left eye and the right eye.

In general, the stereoscopic display technologies may be substantially divided into two major types, which are the glasses type and the naked eye type (auto stereoscopic type). The most popular glasses type stereoscopic display technologies include a shutter glasses type stereoscopic display technology and a polarized glasses type stereoscopic display technology. The stereoscopic display effect of the glasses type stereoscopic display is generally better than the display quality of the naked eye type stereoscopic display. However, the special glasses may still cause inconvenience when using the glasses type stereoscopic display device. Comparatively, the naked eye type stereoscopic display device can work without special glasses. In the general naked eye type stereoscopic display technologies, such as the lenticular lens type stereoscopic display technology, the irradiating directions of different display images are changed by lenses and the different display images are guided toward the left eye or the right eye of the viewer. Accordingly, the viewing angle and the position of the viewer are limited in the naked eye type stereoscopic display technologies. In the lenticular lens type stereoscopic display technology, a liquid crystal lens having lens effect can be formed with the refractive index change due to the liquid crystal molecules. However, how to modify the condition of the driven liquid crystal molecules to reach the optical performance as a real lens is a main objective in the field.

### SUMMARY OF THE INVENTION

One of the objectives of the present invention is to provide a naked eye type and glasses type switchable stereoscopic display device. A switching module which is capable of forming lenses and providing phase retardation effects on light is disposed in front of a display panel, and the display device can accordingly switch between a naked eye type stereoscopic display mode, a glasses type stereoscopic display mode and a normal two-dimensional display mode. Moreover, an electric field uniforming layer is disposed in the switching module to modify the condition of how the liquid crystal molecules are driven in the present invention to improve the optical performances of the formed liquid crystal lenses.

To achieve the purposes described above, an embodiment of the present invention provides a naked eye type and glasses type switchable stereoscopic display device. The naked eye type and glasses type switchable stereoscopic display device includes a display panel and a switching module. The display panel has a display surface. The display panel is used to provide a first display image and a second display image. The switching module is disposed on a side of the display surface of the display panel to receive the first display image and the second display image from the display panel. The switching module includes a first transparent substrate, a second transparent substrate, a first transparent electrode, a second transparent electrode, a liquid crystal layer, and an electric field uniforming layer. The first transparent substrate has a first inner side and a first outer side. The second transparent substrate is disposed oppositely to the first transparent substrate. The second transparent substrate has a second inner side and a second outer side. The second inner side faces the first inner side. The first transparent electrode is disposed between the first transparent substrate and the second transparent substrate, and the second transparent electrode is disposed between the first transparent electrode and the second transparent substrate. The liquid crystal layer is disposed between the first transparent electrode and the second transparent electrode. The liquid crystal layer includes a plurality of liquid crystal molecules. The electric field uniforming layer is disposed between the liquid crystal layer and the second transparent electrode. The liquid crystal molecules are driven by the second transparent electrode through the electric field uniforming layer to form a plurality of liquid crystal lenses in the switching module under a naked eye type stereoscopic display mode. The switching module provides a first phase retardation mode and a second phase retardation mode under a glasses type stereoscopic display mode. The first phase retardation mode corresponds to the first display image and provides to the first display image a first polarization state, and the second phase retardation mode corresponds to the second display image and provides to the second display image a second polarization state.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings are included to provide a further understanding of the embodiments, and are incorporated in and constitute a part of this specification. The drawings illustrate some of the embodiments and, together with the description, serve to explain their principles. In the drawings:

FIG. 1 is a schematic diagram illustrating a naked eye type and glasses type switchable stereoscopic display device according to a first embodiment of the present invention.

FIG. 2 is a schematic diagram illustrating a display condition of the naked eye type and glasses type switchable stereoscopic display device under a naked eye type stereoscopic display mode according to the first embodiment of the present invention.

FIG. 3 is a schematic diagram illustrating a display condition of the naked eye type and glasses type switchable stereoscopic display device under a glasses type stereoscopic display mode according to the first embodiment of the present invention.

FIG. 4 is a schematic diagram illustrating a naked eye type and glasses type switchable stereoscopic display device according to a second embodiment of the present invention.

FIG. 5 is a schematic diagram illustrating a display condition of the naked eye type and glasses type switchable stereoscopic display device under a glasses type stereoscopic display mode according to the second embodiment of the present invention.

FIG. 6 is a schematic diagram illustrating an example of the naked eye type and glasses type switchable stereoscopic display device under the glasses type stereoscopic display mode according to the second embodiment of the present invention.

FIG. 7 is a schematic diagram illustrating a display condition of the naked eye type and glasses type switchable stereoscopic display device under a naked eye type stereoscopic display mode according to the second embodiment of the present invention.

FIG. 8 is a schematic diagram illustrating a display condition of the naked eye type and glasses type switchable stereoscopic display device under a glasses type stereoscopic display mode according to a third embodiment of the present invention.

FIG. 9 is a schematic diagram illustrating an example of the naked eye type and glasses type switchable stereoscopic display device under the glasses type stereoscopic display mode according to the third embodiment of the present invention.

FIG. 10 is a schematic diagram illustrating a display condition of the naked eye type and glasses type switchable stereoscopic display device under a glasses type stereoscopic display mode according to a fourth embodiment of the present invention.

FIG. 11 is a schematic diagram illustrating a display condition of the naked eye type and glasses type switchable stereoscopic display device under a naked eye type stereoscopic display mode according to the fourth embodiment of the present invention.

FIG. 12 is a schematic diagram illustrating a display condition of the naked eye type and glasses type switchable stereoscopic display device under a glasses type stereoscopic display mode according to a fifth embodiment of the present invention.

FIG. 13 is a schematic diagram illustrating a display condition of the naked eye type and glasses type switchable stereoscopic display device under a naked eye type stereoscopic display mode according to the fifth embodiment of the present invention.

FIG. 14 is a schematic diagram illustrating a naked eye type and glasses type switchable stereoscopic display device according to a sixth embodiment of the present invention.

### DETAILED DESCRIPTION

To provide a better understanding of the present disclosure, the embodiments will be described in detail. The embodiments of the present disclosure are illustrated in the accompanying drawings with numbered elements. In addition, the terms such as “first” and “second” described in the present disclosure are used to distinguish different components or processes, which do not limit the sequence of the components or processes.

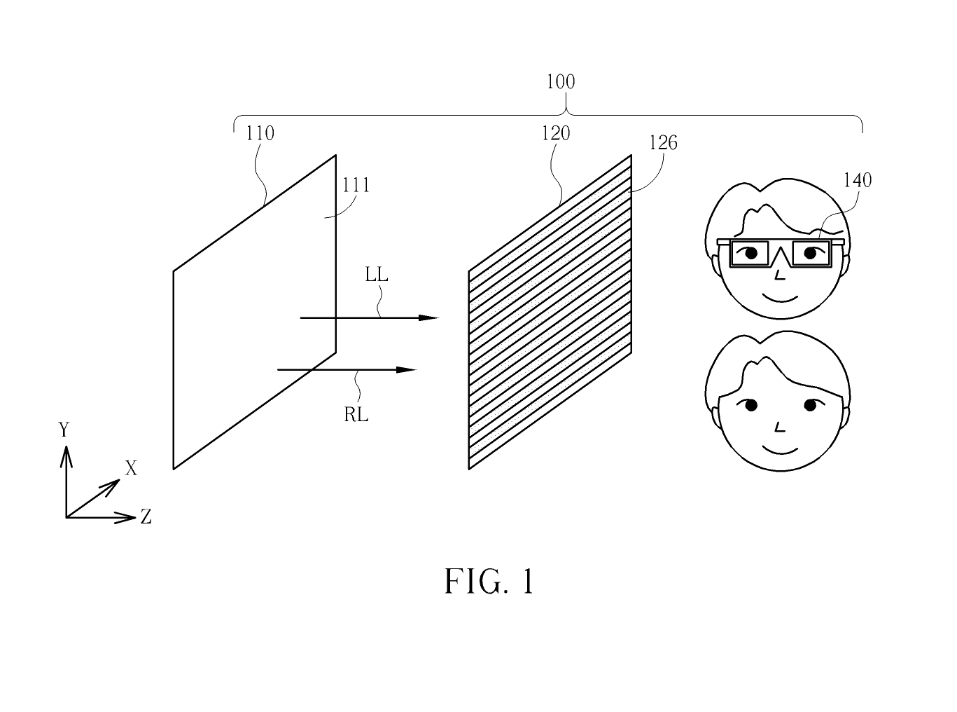

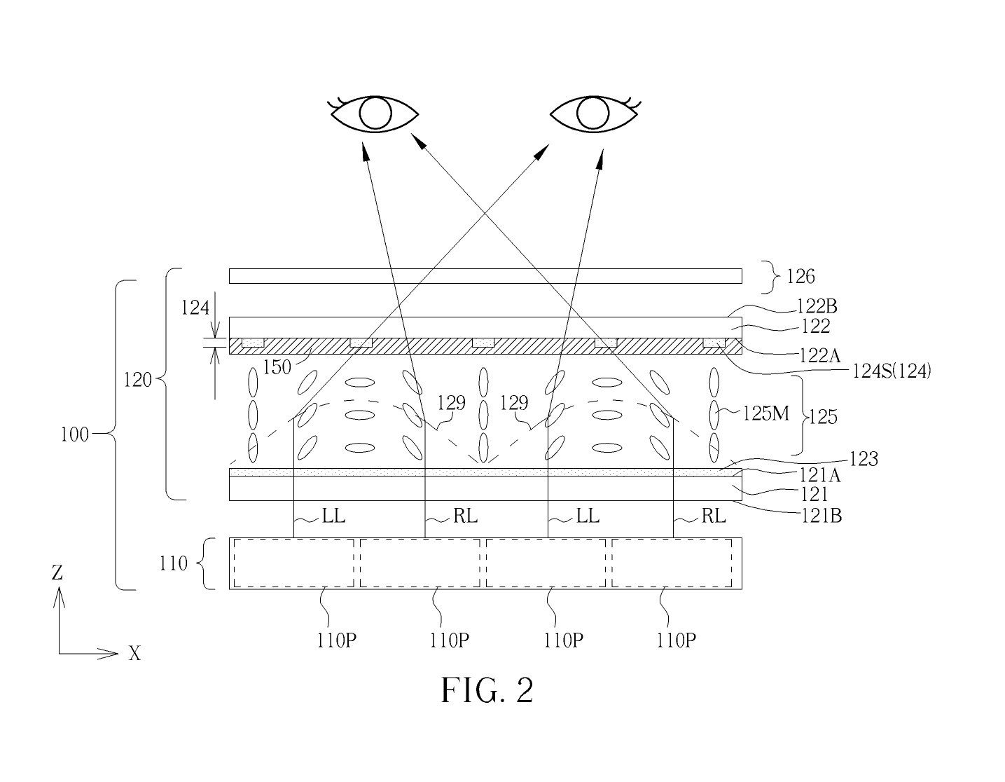

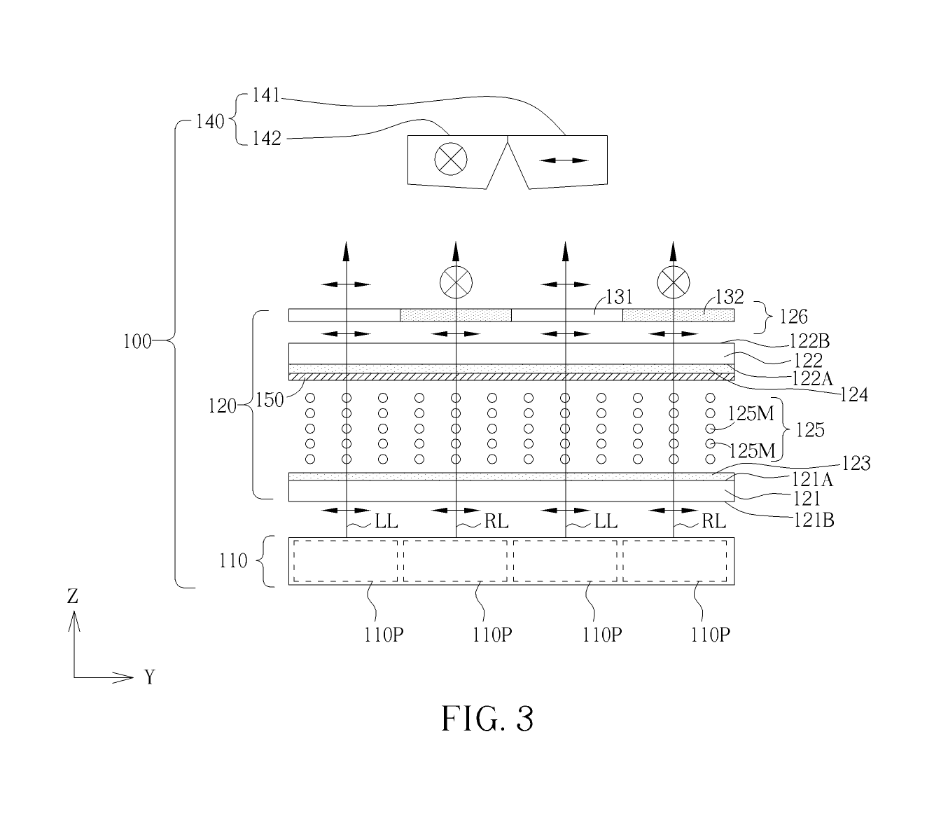

Please refer to FIGS. 1-3. FIGS. 1-3 are schematic diagrams illustrating a naked eye type and glasses type switchable stereoscopic display device according to a first embodiment of the present invention. FIG. 2 is a schematic diagram illustrating a display condition of the naked eye type and glasses type switchable stereoscopic display device in this embodiment under a naked eye type stereoscopic display mode. FIG. 3 is a schematic diagram illustrating a display condition of the naked eye type and glasses type switchable stereoscopic display device in this embodiment under a glasses type stereoscopic display mode. Please note that the figures are only for illustration and the figures may not be to scale. The scale may be further modified according to different design considerations. As shown in FIGS. 1-3, the first embodiment of the present invention provides a naked eye type and glasses type switchable stereoscopic display device 100. The naked eye type and glasses type switchable stereoscopic display device 100 includes a display panel 110 and a switching module 120. The display panel 110 has a display surface 111. The display panel 110 is used to provide first display images LL and second display images RL. The display panel 110 in this embodiment preferably includes a liquid crystal display (LCD) panel, an organic light emitting diode (OLED) display panel, an electro-wetting display panel, an e-ink display panel, a plasma display panel, or a field emitting display (FED) panel, but not limited thereto. The switching module 120 is disposed on a side of the display surface 111 of the display panel 110 to receive the first display image LL and the second display image RL from the display panel 110. The switching module 120 in this embodiment includes a first transparent substrate 121, a second transparent substrate 122, a first transparent electrode 123, a second transparent electrode 124, a liquid crystal layer 125, and an electric field uniforming layer 150. The first transparent substrate 121 has a first inner side 121A and a first outer side 121B. The second transparent substrate 122 is disposed oppositely to the first transparent substrate 121. The second transparent substrate 122 has a second inner side 122A and a second outer side 122B. The second inner side 122A faces the first inner side 121A. The first transparent electrode 123 is disposed between the first transparent substrate 121 and the second transparent substrate 122, and the second transparent electrode 124 is disposed between the first transparent electrode 123 and the second transparent substrate 122. The liquid crystal layer 125 is disposed between the first transparent electrode 123 and the second transparent electrode 124. The liquid crystal layer 125 includes a plurality of liquid crystal molecules 125M. The electric field uniforming layer 150 is disposed between the liquid crystal layer 125 and the second transparent electrode 124; that is to say, the electric field uniforming layer 150 is disposed on a side of the second inner side 122A of the second transparent substrate 122 and covers the second transparent electrode 124. The liquid crystal molecules 125M are driven by the second transparent electrode 124 through the electric field uniforming layer 150 to form a plurality of liquid crystal lenses 129 in the switching module 120 under a naked eye type stereoscopic display mode (as shown in FIG. 2). The liquid crystal lenses 129 are used to modify the direction of the first display image LL and the direction of the second display image RL. The switching module 120 provides a first phase retardation mode 131 and a second phase retardation mode 132 under the glasses type stereoscopic display mode (as shown in FIG. 3). The first phase retardation mode 131 corresponds to the first display image LL and provides a first polarization state to the first display image LL, and the second phase retardation mode 132 corresponds to the second display image RL and provides a second polarization state to the second display image RL.

Furthermore, the switching module 120 in this embodiment further includes a patterned phase retarding layer 126 disposed on a side of the second outer side 122B of the second transparent substrate 122. The patterned phase retarding layer 126 is used to provide the first phase retardation mode 131 and the second phase retardation mode 132 so as to render the first display image LL the first polarization state and render the second display image RL the second polarization state. In addition, the display panel 110 in this embodiment may preferably include a plurality of pixel regions 110P, and the pixel regions 110P are preferably arranged along a first direction X and a second direction Y. The first direction X is preferably perpendicular to the second direction Y, but the present invention is not limited to this and the arrangement of the pixel regions 110P may be further modified according to other considerations. Each of the pixel regions 110P in the display panel 110 is used to provide the first display image LL or the second display image RL along a third direction Z. Each of the pixel regions 110P may include a plurality of sub-pixel regions (not shown) to provide light with different colors or may include only one sub-pixel region to provide a single color according to different design considerations. Additionally, the first display image LL and the second display image RL provided by the display panel 110 preferably are polarized lights. In other words, the display panel 110 preferably includes at least one polarizing film (not shown), but not limited thereto.

As shown in FIG. 2, under the naked eye type display mode in this embodiment, the first display image LL, which is designed to be received by the left eye of the viewer, and the second display image RL, which is designed to be received by the right eye of the viewer, are respectively provided by the pixel regions 110P disposed adjacently to each other along the first direction X synchronously. Under the naked eye type display mode, the liquid crystal molecules 125M are driven to form a plurality of liquid crystal lenses 129. The direction of the first display image LL and the direction of the second display image RL are respectively modified by the liquid crystal lenses 129. In other words, the first display image LL and the second display image RL are respectively guided toward the left eye and the right eye of the viewer after passing through the liquid crystal lenses 129, and the naked eye type stereoscopic display effect may therefore be generated. More specifically, the second transparent electrode 124 may preferably include a plurality of sub electrode patterns 124S, and each of the sub electrode patterns 124S may preferably include a stripe pattern or a polygonal pattern, but not limited thereto. The liquid crystal molecules 125M corresponding to different sub electrode patterns 124S may be aligned in different conditions by applying different voltage values to each of the sub electrode patterns 124S along the first direction X and applying a common voltage to the first transparent electrode 123. The liquid crystal molecules 125M aligned in different conditions may generate different refractive index effects, and an effect of the liquid crystal lenses 129 may then be formed by modifying a distribution of the different refractive index. The electric field uniforming layer 150 is disposed on a side of the second inner side 122A of the second transparent substrate 122 and covers the second transparent electrode 124. The electric field uniforming layer 150 is used to uniform an electric field between two adjacent sub electrode patterns 124S and the first transparent electrode 123 to form the liquid crystal lenses 129. For example, when the voltage applied to two adjacent sub electrode patterns 124S is 5V and 3V, respectively, the electric field uniforming layer 150 is disposed to provide a smooth gradient change to the voltage between the two adjacent sub electrode patterns 124S. In other words, the electric field uniforming layer 150 can prevent a rapid voltage drop between the two adjacent sub electrode patterns 124S from 5V down to 3V so as to generate a better distribution of the optical performances. The electric field uniforming layer 150 in this embodiment preferably comprises a high impedance layer, and the resistance of the electric field uniforming layer 150 between two adjacent sub electrode patterns 124S is preferably between 1 million ohms (MQ) and 50 million ohms to optimize the electric field uniforming performance, but not limited thereto. The electric field uniforming layer 150 preferably comprises polymer, for example Poly-3,4-Ethylenedioxythiophene (PEDOT), or metal oxide, for example indium gallium zinc oxide (IGZO), titanium oxide (TiO2), and zinc oxide (ZnO), but not limited thereto.

In this embodiment, the second transparent electrode 124 may preferably include a plurality of sub electrode patterns 124S, and the first transparent electrode 123 preferably is a full transparent surface electrode, but the present invention is not limited to this. It is worth noting that a variation of the voltage values applied to each of the sub electrode patterns 124S is preferably a gradient variation and the electric field uniforming layer 150 is disposed so as to generate better lenses effects. Additionally, in this embodiment, a birefringence (Δn) of each of the liquid crystal molecules 125M is substantially larger than 0.15, but not limited thereto. A dielectric anisotropy (Δ∈) of each of the liquid crystal molecules 125M is substantially larger than 10 so as to generate better optical performances, but not limited thereto. A forming position of each of the liquid crystal lenses 129 is preferably corresponding to each of the pixel regions 110P so as to generate a better stereoscopic display effect. For example, each of the liquid crystal lenses 129 in this embodiment is disposed correspondingly to two of the pixel regions 110P along the third direction Z, but the present invention is not limited to this. In other embodiments of the present invention, the liquid crystal lenses 129 may also be disposed correspondingly to more than two pixel regions 110P according to other considerations. Under the naked eye type stereoscopic display mode in this embodiment, each of the liquid crystal lenses 129 has an extending direction (not shown), and the extending direction is substantially parallel to the second direction Y so as to match the first display image LL and the second display image RL provided by each of the pixel regions 110P in the display panel 110, but the present invention is not limited to this. In other embodiments of the present invention, the extending direction may also be not parallel to the second direction Y according to other considerations. For example, the liquid crystal lenses 129 may be disposed with a small tilted angle so as to overcome some optical problems, such as the moiré issue.

As shown in FIG. 3, under the glasses type display mode in this embodiment, the first display image LL, which is designed to be received by the left eye of the viewer, and the second display image RL, which is designed to be received by the right eye of the viewer, are respectively provided by the pixel regions 110P disposed adjacently to each other along the second direction Y synchronously. Under the glasses type display mode, the liquid crystal molecules 125M are not driven, and the polarization states of the first display image LL and the second display image RL will not be changed by the liquid crystal molecules 125M. The first phase retardation mode 131 and the second phase retardation mode 132 are provided by the patterned phase retarding layer 126. The first phase retardation mode 131 corresponds to the first display image LL and provides the first polarization state to the first display image LL, and the second phase retardation mode 132 corresponds to the second display image RL and provides the second polarization state to the second display image RL. Additionally, the naked eye type and glasses type switchable stereoscopic display device 100 further includes a pair of polarizer glasses 140. This pair of polarizer glasses 140 includes a first polarization lens 141 and a second polarization lens 142. The first polarization lens 141 allows transmission of the first display image LL with the first polarization state and blocks transmission of the second display image RL with the second polarization state, and the second polarization lens 142 allows transmission of the second display image RL with the second polarization state and blocks transmission of the first display image LL with the first polarization state. The viewer wearing the polarizer glasses 140 can accordingly receive the first display image LL and the second display image, which are designed to be combined for the stereoscopic display effect, respectively to the left eye and the right eye, and a glasses type stereoscopic display effect may then be generated. It is worth noting that the first phase retardation mode 131 preferably is a zero wavelength retardation mode, and the second phased retardation mode 132 preferably is a one-half wavelength retardation mode, but the present invention is not limited to this. In other embodiments of the present invention, the first phase retardation mode 131 may be a one-half wavelength retardation mode and the second phased retardation mode 132 may be a zero wavelength retardation mode according to different considerations. For example, the first display image LL and the second display image RL preferably are polarized in the first polarization state as the first display image LL and the second display image RL are generated from the pixel regions 110P, and the second display image RL is changed to the second polarization state by the second phased retardation mode 132 provided by the patterned phase retarding layer 126. The first polarization state and the second polarization state are preferably orthogonal so as to generate a better image separating effect, but not limited thereto. Additionally, each region of the first phase retardation mode 131 and each region of the second phase retardation mode 132 in the pattern phase retarding layer 126 preferably correspond to each of the pixel regions 110P so as to generate a better stereoscopic display effect.

The switching module 120 in this embodiment may be used to form the liquid crystal lenses 129 or provide the first phase retardation mode 131 and the second phase retardation mode 132, and the first display image LL and the second display image RL generated from the display panel 110 may be processed to generate the naked eye type stereoscopic display effect and the glasses type stereoscopic display effect. It is worth noting that, in this embodiment, a normal two-dimensional display effect may also be provided by the naked eye type and glasses type switchable stereoscopic display device 100 when the liquid crystal molecules 120M are not driven, and the first display image LL and the second display image RL are not specially modified to be received by the left eye and the right eye of the viewer.

The following description will detail the different embodiments of the naked eye type and glasses type switchable stereoscopic display device in the present invention. To simplify the description, identical components in each of the following embodiments are marked with identical symbols. For making it easier to understand the differences between the embodiments, the following description will detail the dissimilarities among different embodiments and the identical features will not be redundantly described.

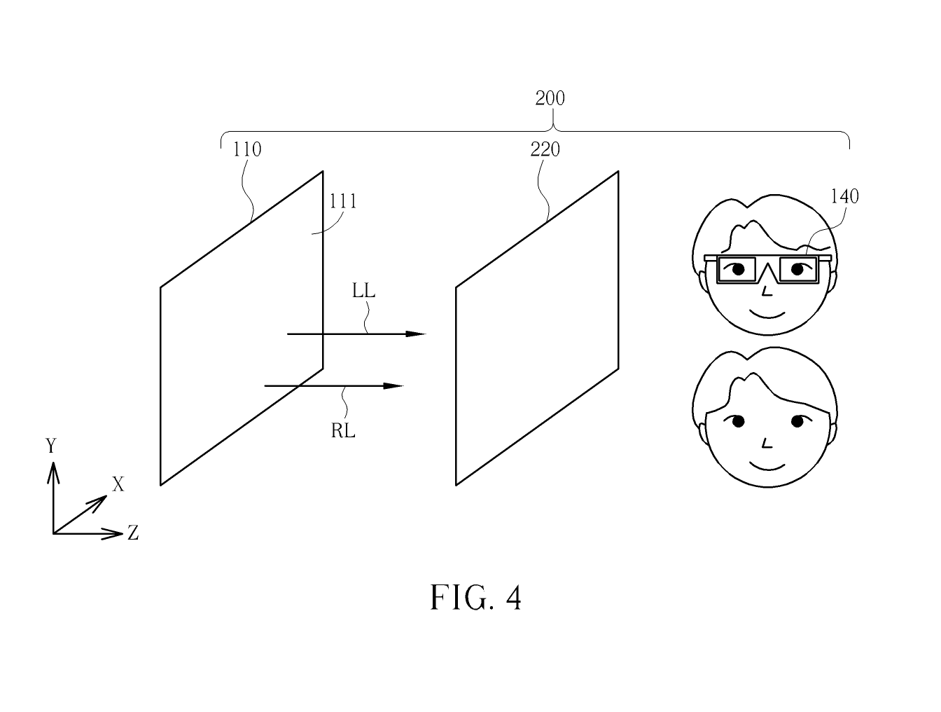

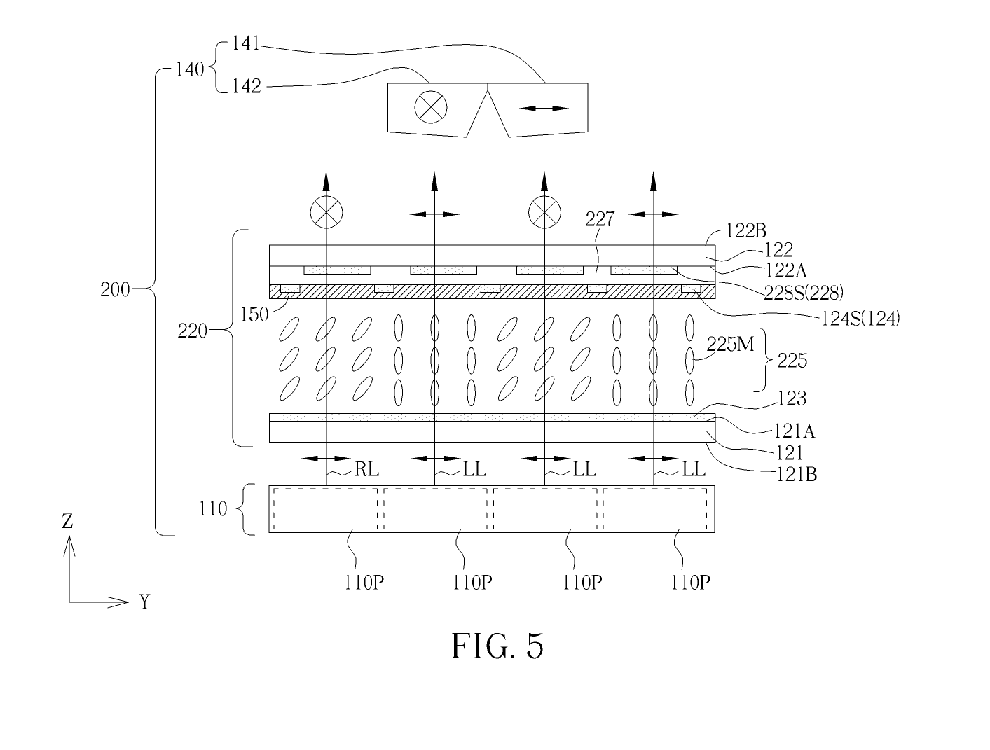

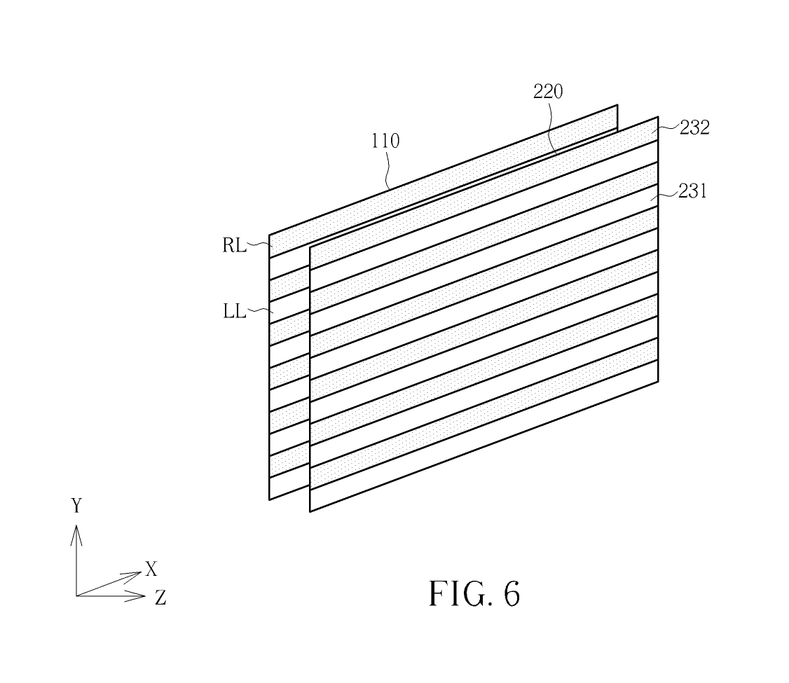

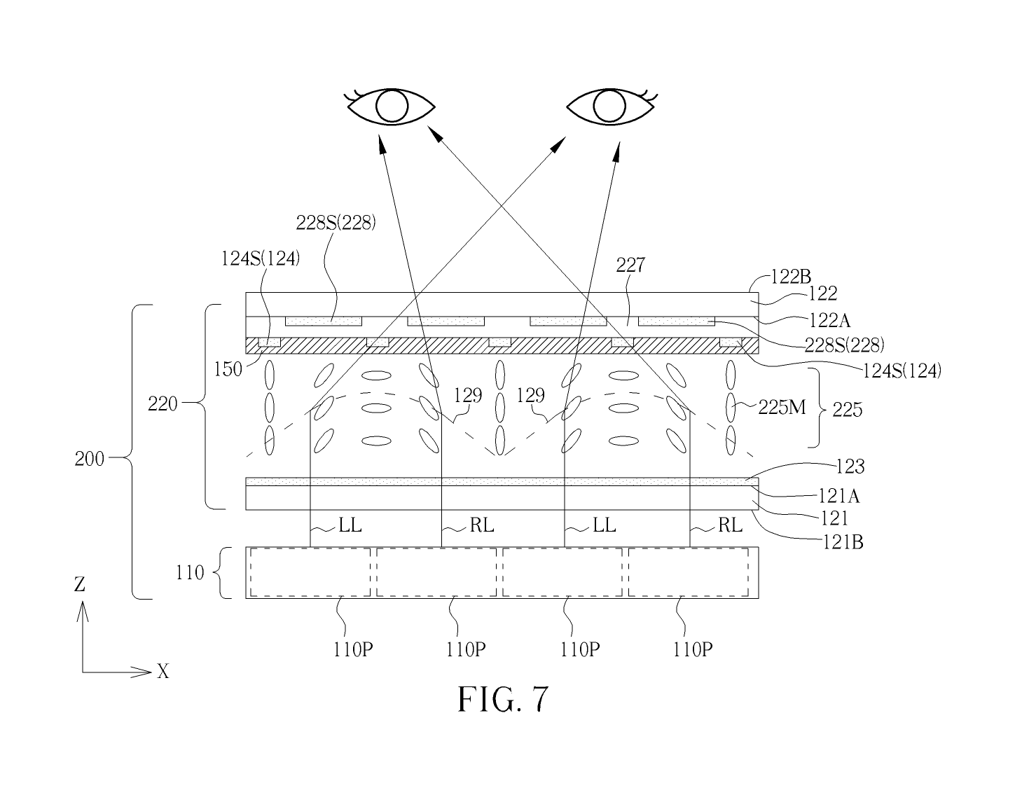

Please refer to FIGS. 4-7. FIGS. 4-7 are schematic diagrams illustrating a naked eye type and glasses type switchable stereoscopic display device according to a second embodiment of the present invention. FIG. 5 is a schematic diagram illustrating a display condition of the naked eye type and glasses type switchable stereoscopic display device in this embodiment under a glasses type stereoscopic display mode. FIG. 6 is a schematic diagram illustrating an example of the naked eye type and glasses type switchable stereoscopic display device in this embodiment under the glasses type stereoscopic display mode. FIG. 7 is a schematic diagram illustrating a display condition of the naked eye type and glasses type switchable stereoscopic display device in this embodiment under a naked eye type stereoscopic display mode. As shown in FIGS. 4-6, the second embodiment of the present invention provides a naked eye type and glasses type switchable stereoscopic display device 200. The naked eye type and glasses type switchable stereoscopic display device 200 includes a display panel 110 and a switching module 220. The switching module 220 is disposed on a side of the display surface 111 of the display panel 110 to receive the first display image LL and the second display image RL provided by the display panel 110. The difference between the naked eye type and glasses type switchable stereoscopic display device 200 of this embodiment and the naked eye type and glasses type switchable stereoscopic display device 100 of the first embodiment is that the switching module 220 in this embodiment includes a first transparent substrate 121, a second transparent substrate 122, a first transparent electrode 123, a second transparent electrode 124, a third transparent electrode 228, a first insulating layer 227, an electric field uniforming layer 150 and a liquid crystal layer 225. The third transparent electrode 228 is disposed between the second transparent substrate 122 and the second transparent electrode 124, the first insulating layer 227 is disposed between the second transparent electrode 124 and the third transparent electrode 228, and the liquid crystal layer 225 is disposed between the electric field uniforming layer 150 and the first transparent electrode 123. The liquid crystal layer 225 includes a plurality of liquid crystal molecules 225M. Additionally, the second transparent electrode 124 in this embodiment may preferably include a plurality of sub electrode patterns 124S, and the third transparent electrode 228 may preferably include a plurality of sub electrode patterns 228S. Each of the sub electrode patterns 124S and each of the sub electrode patterns 228S may preferably include a stripe pattern or a polygonal pattern, and the first transparent electrode 123 is preferably a full transparent surface electrode, but not limited thereto.

As shown in FIG. 5 and FIG. 6, under the glasses type stereoscopic display mode in this embodiment, the display panel 110 simultaneously provides the first display image LL and the second display image RL, and the switching module 220 simultaneously provides a first phase retardation mode 231 and a second phase retardation mode 232 correspondingly. More specifically, the first display image LL, which is designed to be received by the left eye of the viewer, and the second display image RL, which is designed to be received by the right eye of the viewer, are respectively provided by the pixel regions 110P disposed adjacently to each other along the second direction Y synchronously. The switching module 220 simultaneously provides the first phase retardation mode 231 and the second phase retardation mode 232 alternately aligned along the second direction Y. Accordingly, the regions of the first phase retardation mode 231 and the second phase retardation mode 232 in the switching module 220 of this embodiment may be regarded as fixed regions, but not limited thereto. The first phase retardation mode 231 corresponds to the first display image LL and provides a first polarization state to the first display image LL, and the second phase retardation mode 232 corresponds to the second display image RL and provides a second polarization state to the second display image RL. Under the glasses type stereoscopic display mode in this embodiment, the liquid crystal molecules 225M may be driven by controlling an electrical condition between a part of the sub electrode patterns 228S and the first transparent electrode 123, and some of the liquid crystal molecules 225M may then be aligned in a specific manner to provide a phase retardation effect on the light irradiating into the liquid crystal molecules 225M. For example, under the glasses type stereoscopic display mode in this embodiment, the second phase retardation mode 232 is accomplished when the liquid crystal molecules 225M are driven by the first transparent electrode 123 and the corresponding sub electrode patterns 228S of the third transparent electrode 228, and the first phase retardation mode 231 is accomplished when the liquid crystal molecules 225M are not driven by the corresponding sub electrode patterns 228S. In this embodiment, the first phase retardation mode 231 is preferably a zero wavelength retardation mode, and the second phased retardation mode 232 is preferably a one-half wavelength retardation mode, but not limited thereto. It is worth noting that when driving the liquid crystal molecules 225M, the second transparent electrode 124 may be kept in an electrical floating state or a minimal voltage value maybe be applied thereon so as to modify the alignment condition of the liquid crystal molecules 225M, and a required phase retardation effect may be obtained more easily. The method of driving the liquid crystal molecules 225M described above may be regarded as a vertical alignment (VA) liquid crystal driving approach, but the present invention is not limited to this. In other embodiments of the present invention, other appropriate liquid crystal driving approaches, such as an electrically controlled birefringence (ECB) liquid crystal driving approach, or an optically compensated birefringence (OCB) liquid crystal driving approach, may also be used to generate the required phase retardation effect. It is worth noting that the method of driving the switching module 220 in this embodiment may be even more simplified because the first retardation mode 231 and the second retardation mode 232 are respectively provided in the fixed regions of the switching module 220, and other related designs may also be accordingly simplified.

As shown in FIG. 7, under the naked eye type stereoscopic display mode in this embodiment, the first display image LL, which is designed to be received by the left eye of the viewer, and the second display image RL, which is designed to be received by the right eye of the viewer, are respectively provided by the pixel regions 110P disposed adjacently to each other along the first direction X synchronously. Under the naked eye type display mode, the liquid crystal molecules 225M are driven by the second transparent electrode 124 through the electric field uniforming layer 150 to form a plurality of liquid crystal lenses 129. The direction of the first display image LL and the direction of the second display image RL are respectively changed by the liquid crystal lenses 129, and the first display image LL and the second display image RL are respectively guided toward the left eye and the right eye of the viewer after passing through the liquid crystal lenses 129 so as to generate the naked eye type stereoscopic display effect. The display method, the allocation of the liquid crystal lenses 129, and the principle of separating the first display image LL and the second display image RL under the naked eye type stereoscopic display mode of the naked eye type and glasses type switchable stereoscopic display device 200 in this embodiment are similar to those of the naked eye type and glasses type switchable stereoscopic display device 100 in the first embodiment detailed above and will not be redundantly described. Additionally, in this embodiment, a birefringence (Δn) of each of the liquid crystal molecules 225M is substantially larger than 0.15 so as to generate better optical performances, but not limited thereto. A dielectric anisotropy (Δ∈) of each of the liquid crystal molecules 225M is substantially larger than 10 so as to achieve better optical performances, but not limited thereto. In this embodiment, each of the sub electrode patterns 124S of the second transparent electrode 124 and each of the sub electrode patterns 228S of the third transparent electrode 228 are preferably alternately aligned along the first direction X, and the width of each of the sub electrode patterns 124S is preferably thinner than the width of each of the sub electrode patterns 228S so as to achieve better optical performances for the liquid crystal lenses and phase retardation effect simultaneously. However, the present invention is not limited to this; the width and alignment condition of each of the sub electrode patterns 124S and each of the sub electrode patterns 228S can be modified according to other considerations.

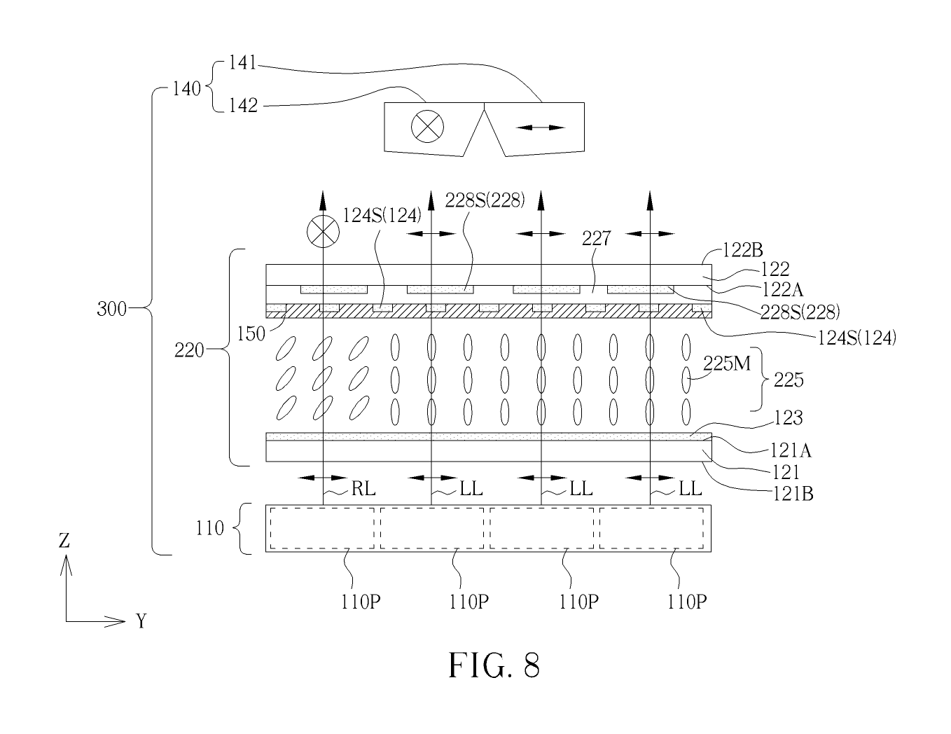

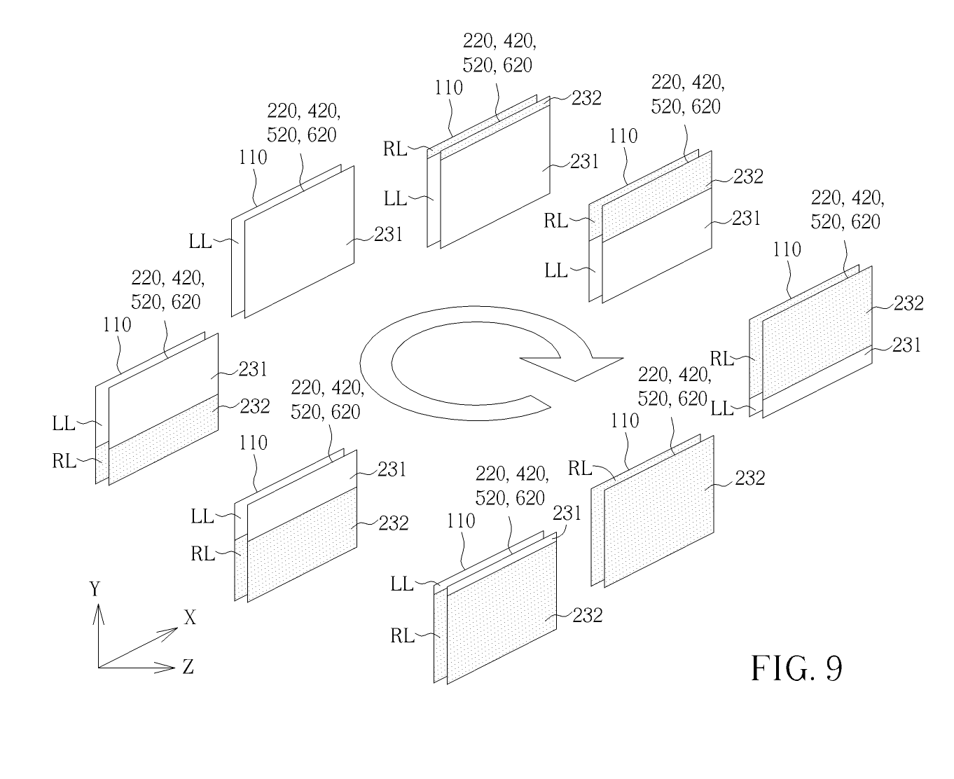

Please refer to FIGS. 8-9. FIGS. 8-9 are schematic diagrams illustrating a naked eye type and glasses type switchable stereoscopic display device according to a third embodiment of the present invention. FIG. 8 is a schematic diagram illustrating a display condition of the naked eye type and glasses type switchable stereoscopic display device in this embodiment under a glasses type stereoscopic display mode. FIG. 9 is a schematic diagram illustrating an example of the naked eye type and glasses type switchable stereoscopic display device in this embodiment under the glasses type stereoscopic display mode. As shown in FIGS. 8-9, the difference between the naked eye type and glasses type switchable stereoscopic display device 300 of this embodiment and the naked eye type and glasses type switchable stereoscopic display device 200 of the second embodiments is that, under the glasses type stereoscopic display mode, the display panel 110 of this embodiment provides the first display image LL and the second display image RL alternately through a scanning method, and the switching module 220 correspondingly provides the first phase retardation mode 231 and the second phase retardation mode 232 alternately. It is worth noting that the first display image LL and the second display image RL are provided alternately through a scanning method, and the first phase retardation mode 231 and the second phase retardation mode 232 are also provided alternately and synchronously. The display images under the glasses type stereoscopic display mode in this embodiment can accordingly be presented in high resolution because the viewer may receive a complete first display image LL and a complete second display image RL respectively at different time points. The resolution of the display image may not be sacrificed for presenting the complete first display image LL and the complete second display image RL at the same time. Apart from the method of providing the first display image LL, the second display image RL, the corresponding first phase retardation mode 231 and the corresponding second phase retardation mode 232 under the glasses type stereoscopic display mode of the naked eye type and glasses type switchable stereoscopic display device 300 in this embodiment, the other components, allocations, material properties, and the operating condition under the naked eye type stereoscopic display mode in this embodiment are similar to those of the naked eye type and glasses type switchable stereoscopic display device 200 in the second embodiment detailed above and will not be redundantly described.

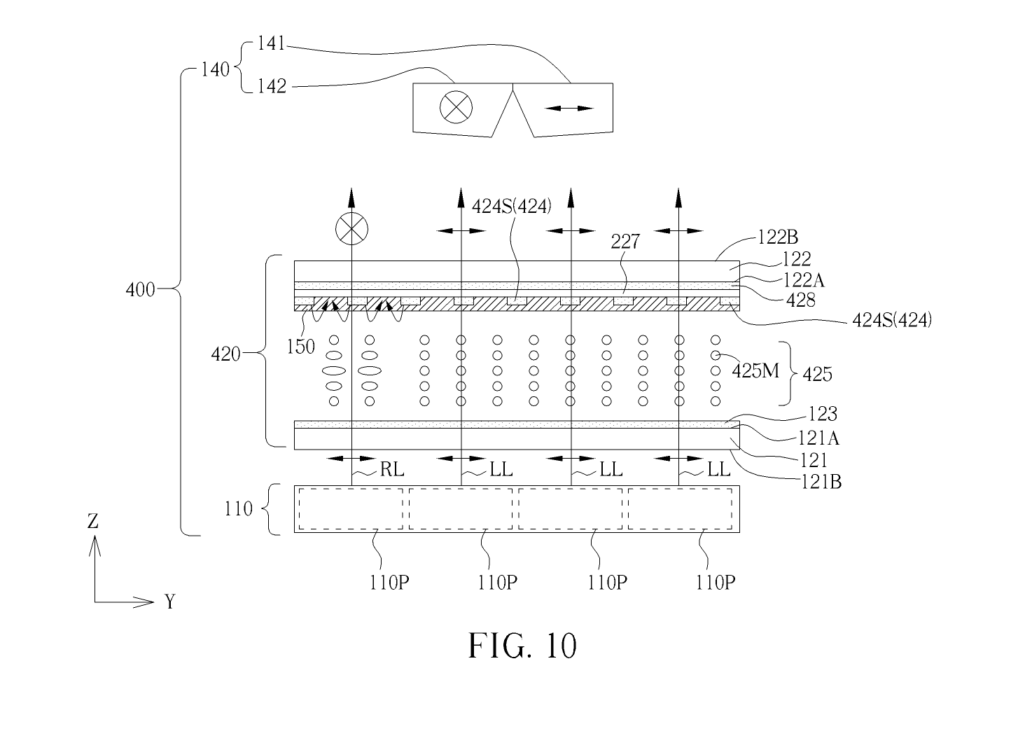

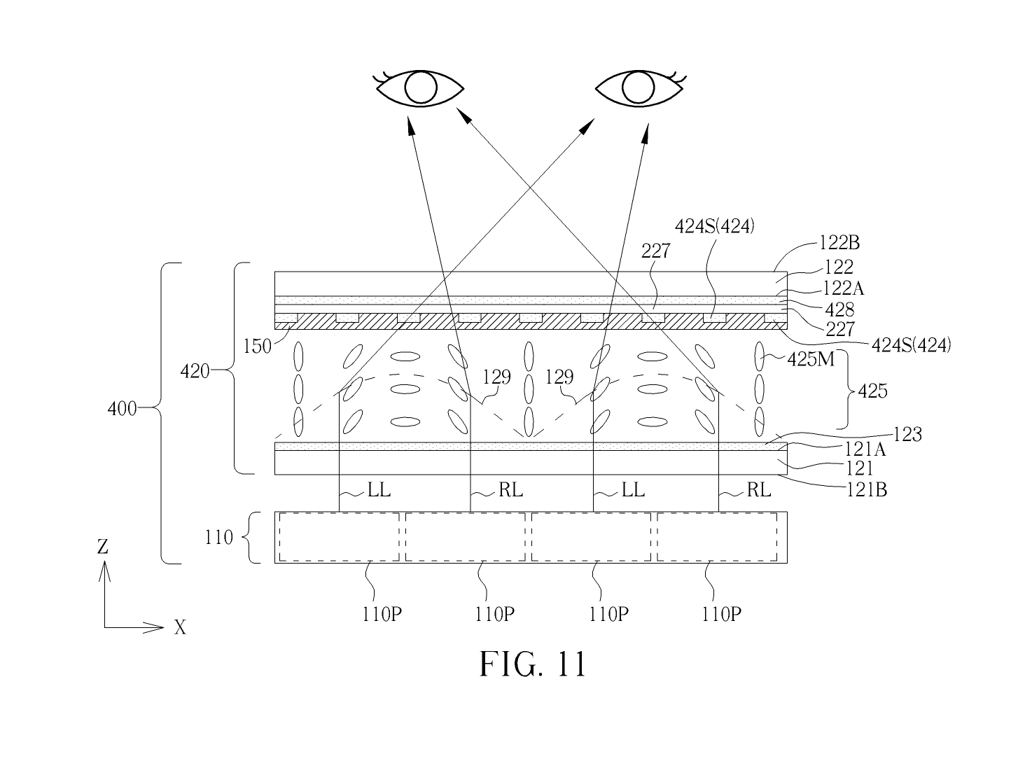

Please refer to FIGS. 10-11, and also refer to FIG. 9. FIGS. 9-11 are schematic diagrams illustrating a naked eye type and glasses type switchable stereoscopic display device according to a fourth embodiment of the present invention. FIG. 9 is a schematic diagram illustrating an example of the naked eye type and glasses type switchable stereoscopic display device in this embodiment under a glasses type stereoscopic display mode. FIG. 10 is a schematic diagram illustrating a display condition of the naked eye type and glasses type switchable stereoscopic display device in this embodiment under the glasses type stereoscopic display mode. FIG. 11 is a schematic diagram illustrating a display condition of the naked eye type and glasses type switchable stereoscopic display device in this embodiment under a naked eye type stereoscopic display mode. As shown in FIGS. 9-11, the fourth embodiment of the present invention provides a naked eye type and glasses type switchable stereoscopic display device 400. The naked eye type and glasses type switchable stereoscopic display device 400 includes a display panel 110 and a switching module 420. The difference between the naked eye type and glasses type switchable stereoscopic display device 400 of this embodiment and the naked eye type and glasses type switchable stereoscopic display device 300 of the third embodiment is that the switching module 420 in this embodiment includes a first transparent substrate 121, a second transparent substrate 122, a first transparent electrode 123, a second transparent electrode 424, a third transparent electrode 428, a first insulating layer 227, an electric field uniforming layer 150, and a liquid crystal layer 425. The liquid crystal layer 425 includes a plurality of liquid crystal molecules 425M. The third transparent electrode 428 is disposed between the first insulating layer 227 and the second transparent substrate 122. Additionally, the third transparent electrode 428 is preferably a full transparent surface electrode, the second transparent electrode 424 in this embodiment may preferably include a plurality of sub electrode patterns 424S, and the first transparent electrode 123 preferably is a full transparent surface electrode, but not limited thereto.

As shown in FIG. 9 and FIG. 10, under the glasses type stereoscopic display mode in this embodiment, the display panel 110 provides the first display image LL and the second display image RL alternately through a scanning method, and the switching module 420 simultaneously provides a first phase retardation mode 231 and a second phase retardation mode 232 alternately. The difference between the naked eye type and glasses type switchable stereoscopic display device of this embodiment and the naked eye type and glasses type switchable stereoscopic display device 300 of the third embodiment is that, under the glasses type stereoscopic display mode in this embodiment, the liquid crystal molecules 425M may be driven by controlling an electrical condition between each of the sub electrode patterns 424S of the second transparent electrode 424 and the third transparent electrode 428, and some of the liquid crystal molecules 425M may then be aligned in a specific manner to provide a phase retardation effect on the light irradiating into the liquid crystal molecules 425M. The second phase retardation mode 232 is achieved when the liquid crystal molecules 425M are driven by the corresponding sub electrode patterns 424S of the second transparent electrode 424, and the first phase retardation mode 231 is achieved when the liquid crystal molecules 425M are not driven by the corresponding sub electrode patterns 424S. It is worth noting that when driving the liquid crystal molecules 425M, the first transparent electrode 123 may be kept in a electrical floating state or a minimal voltage value maybe be applied thereon so as to modify the alignment condition of the liquid crystal molecules 425M, and a required phase retardation effect may be obtained more easily. The method of driving the liquid crystal molecules 425M described above may be regarded as a fringe field switching (FFS) liquid crystal driving approach, but the present invention is not limited to this. In other embodiments of the present invention, other appropriate liquid crystal driving approaches, such as a in plan switch (IPS) liquid crystal driving approach, may also be used to generate the required phase retardation effect. Apart from the method of driving the liquid crystal molecules 425M under the glasses type stereoscopic display mode of the naked eye type and glasses type switchable stereoscopic display device 400 in this embodiment, the other components, allocations, material properties, and the principle of separating the first display image LL and the second display image RL in this embodiment are similar to those of the naked eye type and glasses type switchable stereoscopic display device 300 in the third embodiment detailed above and will not be redundantly described. It is worth noting that, in other embodiments of the present invention, through the fixed phase retardation effect formed by the switching module 420 in the naked eye type and glasses type switchable stereoscopic display device 400 (as described in the above second embodiment) and the method to provide the first display image LL and the second display image RL from the display panel 110, the glasses type stereoscopic display effect may also be generated.

As shown in FIG. 11, under the naked eye type stereoscopic display mode in this embodiment, the liquid crystal molecules 425M are driven by a plurality of sub electrode patterns 424S of the second transparent electrode 424 through the electric field uniforming layer 150 to form a plurality of liquid crystal lenses 129. The direction of the first display image LL and the direction of the second display image RL are respectively changed by the liquid crystal lenses 129, and the first display image LL and the second display image RL are respectively guided toward the left eye and the right eye of the viewer after passing through the liquid crystal lenses 129 so as to generate the naked eye type stereoscopic display effect. The display method, the allocation of the liquid crystal lenses 129, and the principle of separating the first display image LL and the second display image RL under the naked eye type stereoscopic display mode of the naked eye type and glasses type switchable stereoscopic display device 400 in this embodiment are similar to those of the naked eye type and glasses type switchable stereoscopic display device 100 in the first embodiment detailed above and will not be redundantly described. It is worth noting that, in this embodiment, a birefringence (Δn) of each of the liquid crystal molecules 425M is substantially larger than 0.15 so as to achieve better optical performances, but not limited thereto. A dielectric anisotropy (Δ∈) of each of the liquid crystal molecules 425M is substantially larger than 10 so as to generate better optical performances, but not limited thereto.

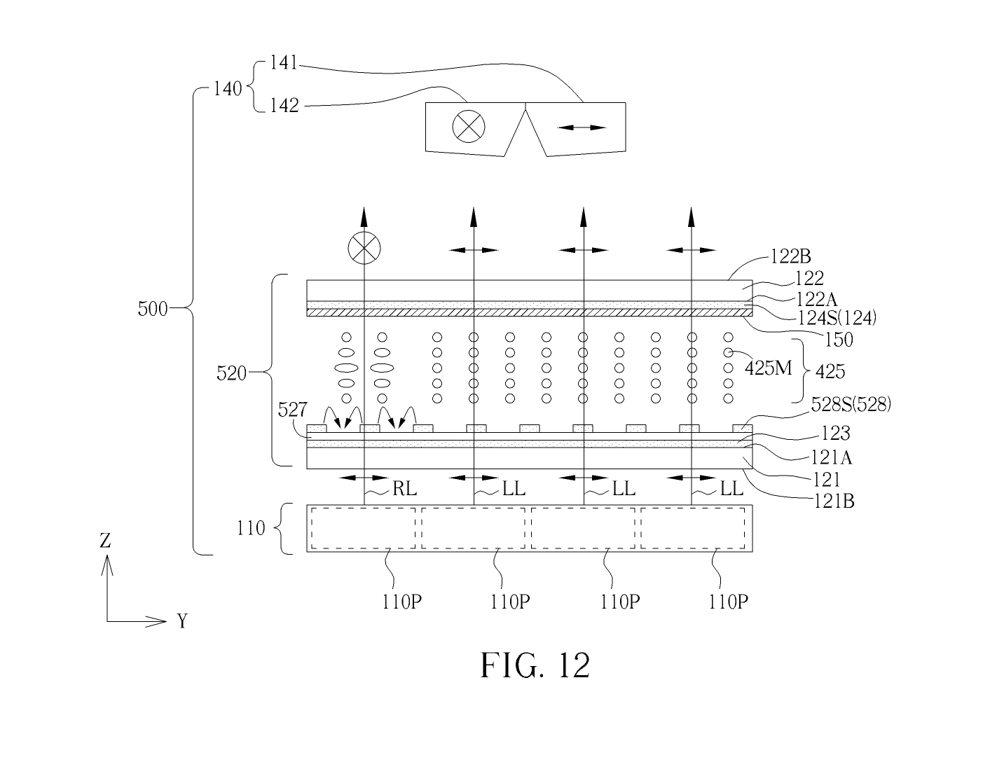

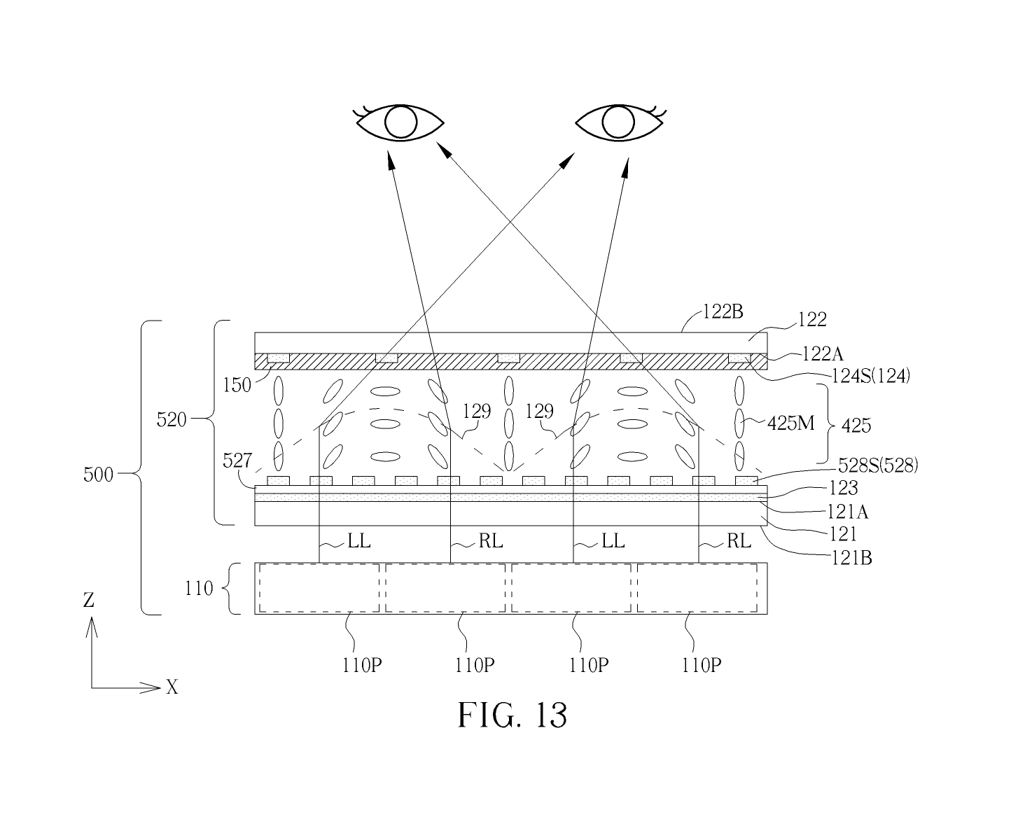

Please refer to FIGS. 12-13, and also refer to FIG. 9. FIG. 9 and FIGS. 12-13 are schematic diagrams illustrating a naked eye type and glasses type switchable stereoscopic display device according to a fifth embodiment of the present invention. FIG. 9 is a schematic diagram illustrating an example of the naked eye type and glasses type switchable stereoscopic display device in this embodiment under a glasses type stereoscopic display mode. FIG. 12 is a schematic diagram illustrating a display condition of the naked eye type and glasses type switchable stereoscopic display device in this embodiment under the glasses type stereoscopic display mode. FIG. 13 is a schematic diagram illustrating a display condition of the naked eye type and glasses type switchable stereoscopic display device in this embodiment under a naked eye type stereoscopic display mode. As shown in FIG. 9 and FIG. 12, the fifth embodiment of the present invention provides a naked eye type and glasses type switchable stereoscopic display device 500. The naked eye type and glasses type switchable stereoscopic display device 500 includes a display panel 110 and a switching module 520. The difference between the naked eye type and glasses type switchable stereoscopic display device 500 of this embodiment and the naked eye type and glasses type switchable stereoscopic display device 400 of the fourth embodiment is that the switching module 520 in this embodiment includes a first transparent substrate 121, a second transparent substrate 122, a first transparent electrode 123, a second transparent electrode 124, a fourth transparent electrode 528, a second insulating layer 527, an electric field uniforming layer 150, and a liquid crystal layer 425. The fourth transparent electrode 528 is disposed between the first transparent electrode 123 and the liquid crystal layer 425. The second insulating layer 527 is disposed between the first transparent electrode 123 and the fourth transparent electrode 528. Additionally, the fourth transparent electrode 528 in this embodiment may preferably include a plurality of sub electrode patterns 528S, and the first transparent electrode 123 is preferably a full transparent surface electrode, but not limited thereto.

As shown in FIG. 9 and FIG. 12, under the glasses type stereoscopic display mode in this embodiment, the display panel 110 provides the first display image LL and the second display image RL alternately through a scanning method, and the switching module 520 simultaneously provides a first phase retardation mode 231 and a second phase retardation mode 232 alternately. The difference between the naked eye type and glasses type switchable stereoscopic display device of this embodiment and the naked eye type and glasses type switchable stereoscopic display device 400 of the fourth embodiment is that, under the glasses type stereoscopic display mode in this embodiment, the liquid crystal molecules 425M may be driven by controlling an electrical condition between a part of the sub electrode patterns 528S of the fourth transparent electrode 528 and the first transparent electrode 123, and some of the liquid crystal molecules 425M may then be aligned in a specific manner to provide a phase retardation effect on the light irradiating into the liquid crystal molecules 425M. The second phase retardation mode 232 is accomplished when the liquid crystal molecules 425M are driven by the corresponding sub electrode patterns 528S of the fourth transparent electrode 528, and the first phase retardation mode 231 is accomplished when the liquid crystal molecules 425M are not driven by the corresponding sub electrode patterns 528S. Apart from the fourth transparent electrode 528 and the second insulating layer 527 of the naked eye type and glasses type switchable stereoscopic display device 500 in this embodiment, the other components, allocations, material properties, and the principle of separating the first display image LL and the second display image RL in this embodiment are similar to those of the naked eye type and glasses type switchable stereoscopic display device 400 in the fourth embodiment detailed above and will not be redundantly described. It is worth noting that, in other embodiments of the present invention, through the fixed phase retardation effect formed by the switching module 520 in the naked eye type and glasses type switchable stereoscopic display device 500 (as described in the above second embodiment) and the method to provide the first display image LL and the second display image RL from the display panel 110, the glasses type stereoscopic display effect may be also generated.

As shown in FIG. 13, under the naked eye type stereoscopic display mode in this embodiment, the liquid crystal molecules 425M are driven by a plurality of sub electrode patterns 124S of the second transparent electrode 124 through the electric field uniforming layer 150 to form a plurality of liquid crystal lenses 129. The direction of the first display image LL and the direction of the second display image RL are respectively changed by the liquid crystal lenses 129, and the first display image LL and the second display image RL are respectively guided toward the left eye and the right eye of the viewer after passing through the liquid crystal lenses 129 so as to generate the naked eye type stereoscopic display effect. The display method, the allocation of the liquid crystal lenses 129, and the principle of separating the first display image LL and the second display image RL under the naked eye type stereoscopic display mode of the naked eye type and glasses type switchable stereoscopic display device 500 in this embodiment are similar to those of the naked eye type and glasses type switchable stereoscopic display device 100 in the first embodiment detailed above and will not be redundantly described. It is worth noting that, in this embodiment, the liquid crystal lenses 129 may be formed in the switching module 520 by applying different voltage values to each of the sub electrode patterns 124S aligned along the first direction X and applying a common voltage to the first transparent electrode 123 and the fourth transparent electrode 528, but not limited thereto.

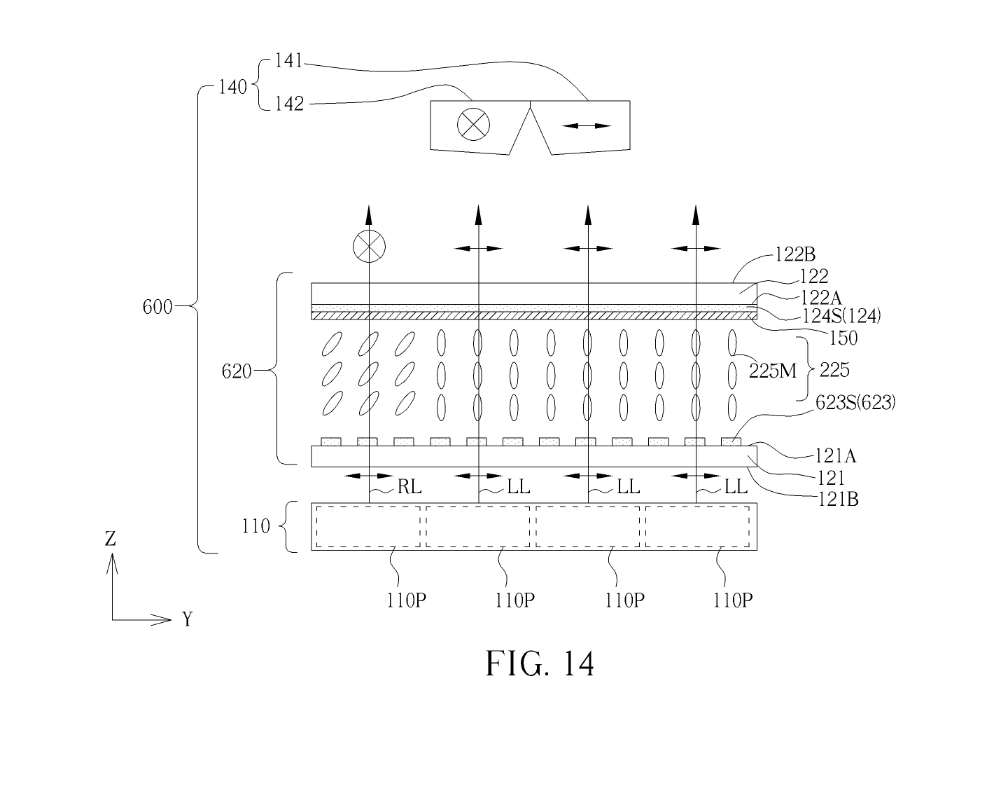

Please refer to FIG. 9 and FIG. 14. FIG. 9 and FIG. 14 are schematic diagrams illustrating a naked eye type and glasses type switchable stereoscopic display device according to a sixth embodiment of the present invention. FIG. 9 is a schematic diagram illustrating an example of the naked eye type and glasses type switchable stereoscopic display device in this embodiment under a glasses type stereoscopic display mode. FIG. 14 is a schematic diagram illustrating a display condition of the naked eye type and glasses type switchable stereoscopic display device in this embodiment under the glasses type stereoscopic display mode. As shown in FIG. 9 and FIG. 14, the sixth embodiment of the present invention provides a naked eye type and glasses type switchable stereoscopic display device 600. The naked eye type and glasses type switchable stereoscopic display device 600 includes a display panel 110 and a switching module 620. The switching module 620 in this embodiment includes a first transparent substrate 121, a second transparent substrate 122, a first transparent electrode 623, a second transparent electrode 124, an electric field uniforming layer 150, and a liquid crystal layer 225. The first transparent electrode 623 in this embodiment may preferably include a plurality of sub electrode patterns 623S, and the second transparent electrode 124 in this embodiment may preferably include a plurality of sub electrode patterns 124S, but not limited thereto. The difference between the naked eye type and glasses type switchable stereoscopic display device 600 of this embodiment and the naked eye type and glasses type switchable stereoscopic display device 400 of the fourth embodiment is that, under a glasses type stereoscopic display mode, in this embodiment the second phase retardation mode 232 is accomplished when the liquid crystal molecules 225M are driven by the corresponding sub electrode patterns 623S of the first transparent electrode 623 and the second transparent electrode 124, and the first phase retardation mode 231 is accomplished when the liquid crystal molecules 225M are not driven by the corresponding sub electrode patterns 623S. The relation between the phase retardation modes and the corresponding display image in this embodiment is similar to the second embodiment described above and will not be redundantly described. It is worth noting that the method of driving the liquid crystal molecules 225M in this embodiment may be regarded as a kind of vertical alignment (VA) liquid crystal driving approach, but not limited thereto. Moreover, in other embodiments of the present invention, through the fixed phase retardation effect formed by the switching module 620 in the naked eye type and glasses type switchable stereoscopic display device 600 (as described in the above second embodiment) and the method to provide the first display image LL and the second display image RL from the display panel 110, the glasses type stereoscopic display effect may be also generated. Additionally, the operating condition of the naked eye type and glasses type switchable stereoscopic display device 600 under a naked eye type stereoscopic display mode is similar to that of the naked eye type and glasses type switchable stereoscopic display device 100 of the first embodiment described above and will not be redundantly described.

To summarize the above descriptions, in the naked eye type and glasses type switchable stereoscopic display device of the present invention, the switching module that is capable of forming the liquid crystal lenses and providing the phase retardation effects on the light is disposed in front of the display panel, and the display device may be accordingly switched between the naked eye type stereoscopic display mode, the glasses type stereoscopic display mode, and the normal two-dimensional display mode. The naked eye type and glasses type switchable stereoscopic display device may be switched to the glasses type stereoscopic display mode for high resolutions, and the naked eye type and glasses type switchable stereoscopic display device may be switched to the naked eye type stereoscopic display mode for watching without the glasses. The users with different demands may be satisfied with the multiple display modes provided by the naked eye type and glasses type switchable stereoscopic display device of the present invention. Moreover, the electric field uniforming layer is disposed in the switching module to modify the condition of how the liquid crystal molecules are driven in the present invention to improve the optical performances of the formed liquid crystal lenses.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A naked eye type and glasses type switchable stereoscopic display device, comprising:
a display panel, having a display surface, wherein the display panel is used to provide a first display image and a second display image; and
a switching module, disposed on a side of the display surface of the display panel to receive the first display image and the second display image from the display panel, wherein the switching module comprises:
a first transparent substrate, having a first inner side and a first outer side;
a second transparent substrate, disposed oppositely to the first transparent substrate, wherein the second transparent substrate has a second inner side and a second outer side, and the second inner side faces the first inner side;
a first transparent electrode, disposed between the first transparent substrate and the second transparent substrate;
a second transparent electrode, disposed between the first transparent electrode and the second transparent substrate;
a liquid crystal layer, disposed between the first transparent electrode and the second transparent electrode, wherein the liquid crystal layer comprises a plurality of liquid crystal molecules; and
an electric field uniforming layer, disposed between the liquid crystal layer and the second transparent electrode,
wherein the liquid crystal molecules are driven by the second transparent electrode through the electric field uniforming layer to form a plurality of liquid crystal lenses in the switching module under a naked eye type stereoscopic display mode, and the switching module provides a first phase retardation mode and a second phase retardation mode under a glasses type stereoscopic display mode, wherein the first phase retardation mode corresponds to the first display image and provides a first polarization state to the first display image, and the second phase retardation mode corresponds to the second display image and provides a second polarization state to the second display image.

2. The naked eye type and glasses type switchable stereoscopic display device according to claim 1, wherein the second transparent electrode comprises a plurality of sub electrode patterns, and under the naked eye type stereoscopic display mode, the electric field uniforming layer is used to uniform an electric field between two adjacent sub electrode patterns and the first transparent electrode to form the liquid crystal lenses.

3. The naked eye type and glasses type switchable stereoscopic display device according to claim 2, wherein the electric field uniforming layer comprises a high impedance layer, and the resistance of the electric field uniforming layer between two adjacent sub electrode patterns of the second transparent electrode is between 1 million ohms (MQ) and 50 millions ohms.

4. The naked eye type and glasses type switchable stereoscopic display device according to claim 1, wherein the electric field uniforming layer comprises polymer or metal oxide.

5. The naked eye type and glasses type switchable stereoscopic display device according to claim 1, wherein a birefringence (Δn) of each of the liquid crystal molecules is substantially larger than 0.2, and a dielectric anisotropy (Δ∈) of each of the liquid crystal molecules is substantially larger than 10.

6. The naked eye type and glasses type switchable stereoscopic display device according to claim 1, wherein the switching module further comprises a patterned phase retarding layer disposed on a side of the second outer side of the second transparent substrate, and the patterned phase retarding layer is used to provide to the first display image the first polarization state and to the second display image the second polarization state.

7. The naked eye type and glasses type switchable stereoscopic display device according to claim 1, wherein the switching module further comprises a first insulating layer and a third transparent electrode, the third transparent electrode is disposed between the second transparent substrate and the second transparent electrode, and the first insulating layer is disposed between the second transparent electrode and the third transparent electrode.

8. The naked eye type and glasses type switchable stereoscopic display device according to claim 7, wherein the third transparent electrode comprises a plurality of sub electrode patterns, and under the glasses type stereoscopic display mode, the second phase retardation mode is accomplished when the liquid crystal molecules are driven by the corresponding sub electrode patterns, and the first phase retardation mode is accomplished when the liquid crystal molecules are not driven by the corresponding sub electrode patterns.

9. The naked eye type and glasses type switchable stereoscopic display device according to claim 1, wherein the switching module further comprises a second insulating layer and a fourth transparent electrode, the fourth transparent electrode is disposed between the first transparent electrode and the liquid crystal layer, and the second insulating layer is disposed between the first transparent electrode and the fourth transparent electrode.

10. The naked eye type and glasses type switchable stereoscopic display device according to claim 9, wherein the fourth transparent electrode comprises a plurality of sub electrode patterns, and under the glasses type stereoscopic display mode, the second phase retardation mode is accomplished when the liquid crystal molecules are driven by the corresponding sub electrode patterns, and the first phase retardation mode is accomplished when the liquid crystal molecules are not driven by the corresponding sub electrode patterns.

11. The naked eye type and glasses type switchable stereoscopic display device according to claim 1, wherein the first phase retardation mode is a zero wavelength retardation mode, and the second phased retardation mode is a one-half wavelength retardation mode.

12. The naked eye type and glasses type switchable stereoscopic display device according to claim 1, further comprising a pair of polarizer glasses having a first polarization lens and a second polarization lens, wherein under the glasses type stereoscopic display mode, the first polarization lens allows transmission of the first display image in the first polarization state and blocks the second display image in the second polarization state, and the second polarization lens allows transmission of the second display image in the second polarization state and blocks the first display image in the first polarization state.

13. The naked eye type and glasses type switchable stereoscopic display device according to claim 1, wherein the display panel comprises a liquid crystal display (LCD) panel, an organic light emitting diode (OLED) display panel, an electro-wetting display panel, an e-ink display panel, a plasma display panel, or a field emitting display (FED) panel.
